(19) United States
(12) Patent Application Publication
(10) Pub. No.: US 2020/0403439 A1
(43) Pub. Date: Dec. 24, 2020

(54) PORTABLE POWER-SUPPLYING DEVICE

(71) Applicant: HONDA MOTOR CO., LTD., Tokyo (JP)

(72) Inventors: Sho Takada, Wako-shi (JP); Nobuyuki Sasaki, Wako-shi (JP); Mitsuhiro Ito, Wako-shi (JP); Mio Oshima, Wako-shi (JP); Yoshihiro Matsunaga, Wako-shi (JP); Ryo Oshima, Wako-shi (JP)

(73) Assignee: HONDA MOTOR CO., LTD., Tokyo (JP)

(21) Appl. No.: 17/011,168

(22) Filed: Sep. 3, 2020

Related U.S. Application Data
(63) Continuation of application No. PCT/JP2018/044960, filed on Dec. 6, 2018.

(30) Foreign Application Priority Data
Mar. 20, 2018 (JP) 2018-052594

(51) Int. Cl. H02J 7/16

(52) U.S. Cl. CPC H02J 7/16; H02J 2310/70

(57) ABSTRACT

A power-supply measures a voltage and a current supplied to a load, obtains a feature amount of the load from the voltage and the current, estimates what a load connected with the power-supply is, based on the feature amount, determines, if the load has high and low power consumption states, whether or not the load has shifted from the high power consumption state to the low power consumption state, activates the engine and supplies the power generated by a generator to the load in a case where an operation state of the load is the high power consumption state, and stops the engine and supplies the power stored in a battery to the load in a case where the state of the load has shifted from the high power consumption state to the low power consumption state.

### CROSS-REFERENCE TO RELATED APPLICATION(S)

This application is a continuation of International Patent Application No. PCT/JP2018/044960 filed on Dec. 6, 2018, which claims priority to and the benefit of Japanese Patent Application No. 2018-052594 filed on Mar. 20, 2018, the entire disclosures of which are incorporated herein by reference.

### BACKGROUND OF THE INVENTION

### Field of the Invention

The present invention relates to a portable power-supplying device such as a power generator and storage battery.

### Description of the Related Art

A power generator is configured to be connected with various loads (electric devices). In the case of an engine-driven type power generator, the engine-driven type power generator cannot generate power if fuel runs out. For example, if the fuel runs out before a rice cooker completes cooking of rice, it would result in not only failure of cooking the rice but also wasting the rice. Thus, it is considered that, if it is possible to estimate a type or name of the load connected to the power generator, it would become possible to determine whether or not the power generator still has enough fuel to supply enough power to the load.

Patent Literature 1 describes a configuration for determining an operation state of an electric device by causing a neural network to learn about a fundamental wave and a high harmonic wave of a current and the operation state of the electric device. Patent Literature 2 describes a configuration for determining whether or not a load is in an operation state, by frequency analysis of a fundamental wave and a high harmonic wave of a current.

### CITATION LIST

### Patent Literature

### PTL1: Japanese Patent Laid-Open No. 2000-292465

### PTL2: Japanese Patent Laid-Open No. 2007-003296

According to Patent Literature 1, it is necessary to have a vast number of pieces of training data for the learning of the neural network. In the first place, Patent Literature 1 is not a technique for determining the type of load. Patent Literature 2 requires the frequency analysis, thereby requiring a huge amount of calculation. Moreover, Patent Literature 2 is also not a technique for determining the type of load. The present invention estimates the type of load from a feature amount of the load connected to the portable power-supplying device. Furthermore, an object of the present invention is to attain such power supply that, if the load connected with the portable power-supply device has shifted from a heating state to a warming state, an engine is stopped and the power is supplied from a storage battery.

### SUMMARY OF THE INVENTION

The present invention, for example, provides a portable power-supplying device, comprising: a power generator that generates power by being driven by an engine; a storage battery being chargeable with power generated by the power generator; a measuring unit configured to measure a voltage and a current supplied to a load; a calculating unit configured to calculate out a feature amount of the load from a measurement value of the voltage and a measurement value of the current measured by the measuring unit; a storage unit configured to store feature amounts of loads in advance; a load estimating unit configured to estimate what a load connected with the power-supplying device is, on the basis of the feature amount calculated out by the calculating unit and the feature amounts stored in the storage unit; a state determining unit configured to determine, if a load estimated by the load estimating unit has a warming function for keeping warm, whether or not the load has shifted from a heating state to a warming state, on the basis of the current measured by the measuring unit; and a control unit configured to activate the engine and supply the power generated by the power generator to the load in a case where an operation state of the load is the heating state, and stop the engine and supply the power stored in the storage battery to the load in a case where the operation state of the load has shifted from the heating state to the warming state.

Further features of the present invention will become apparent from the following description of exemplary embodiments (with reference to the attached drawings).

### BRIEF DESCRIPTION OF THE DRAWINGS

FIG. 1 is a view for explaining a configuration example of a power-supplying device.

FIG. 2 is a block diagram for explaining a control circuit of the power-supplying device.

FIG. 3 is a view for explaining a feature amount map that may be included in feature amount data.

FIG. 4 is a view for explaining power data.

FIG. 5 is a flowchart illustrating a load estimating method.

FIG. 6 is a flowchart illustrating a load x estimating method.

### DESCRIPTION OF THE EMBODIMENTS

[Power-Supplying Device]

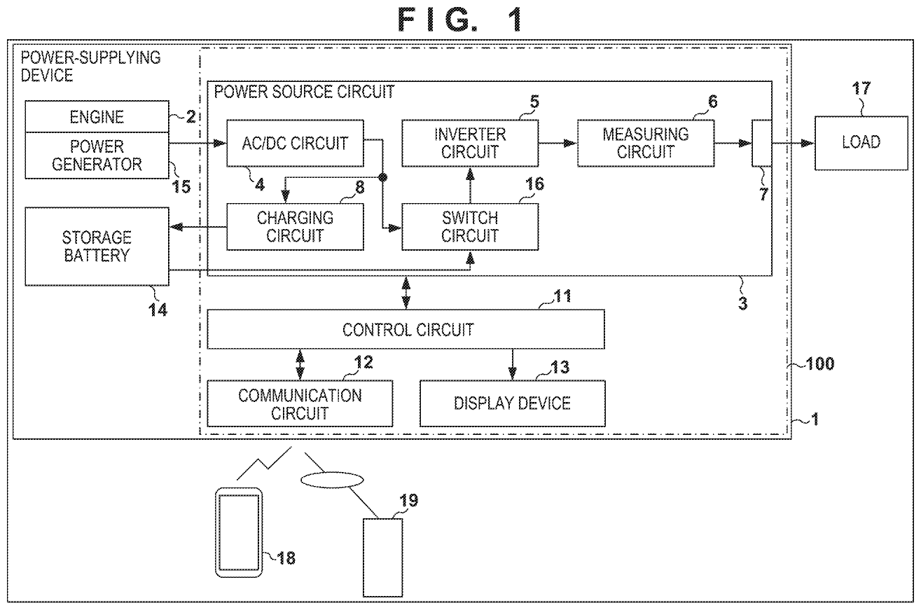

FIG. 1 is a block diagram illustrating a power-supplying device 1. The power-supplying device 1 is a device capable of supplying power to one or more loads (electric devices). The power-supplying device 1 may be, for example, a portable engine-driven power generator, which can be used outdoor such as at a campsite. An engine 2 is an internal-combustion engine configured to operate, replying on fuel supplied from a fuel tank. A power generator 15 is a power generator configured to generate power by being driven by the engine 2. The fuel may be, for example, gasoline, liquefied petroleum gas, hydrogen, or the like. A power source circuit 3 is a circuit configured to convert a voltage thus generated by the power generator 15 into a predetermined alternating current or direct current. An AC/DC circuit 4 includes circuits such as a rectifying and smoothing circuit configured to rectify and smooth the alternating current thus generated by the power generator 15. An inverter circuit 5 is a circuit configured to convert a direct current outputted from the AC/DC circuit 4 or a storage battery 14 into an alternating current having a predetermined stable frequency. A measuring circuit 6 is configured to measure an alternating voltage and an alternating current supplied to a load 17 connected to an AC outlet 7, and to output measurement results to a control circuit 11. The AC outlet 7 may be provided with a receptacle thereby to be connectable with the load 17. A control circuit 11 is a circuit configured to control the power source circuit 3, a communication circuit 12, a display device 13, and the like. The communication circuit 12 is a circuit configured to communicate with a smartphone 18 or a PC (personal computer) 19 via wired communication or wireless communication. The PC 19 may be a server device connected with the Internet. The display device 13 is configured to output, for example, information indicating a type of load to a user. The display device 13 may include a touch-screen type input device. The control circuit 11 is configured to calculate a feature amount of the load on the basis of the measurement results of the measuring circuit 6, and to estimate what the load is (type, name, or the like) on the basis of the feature amount. In case where the load thus estimated has a warming function for keeping warm or a power saving mode (low power consumption mode), the control circuit 11 causes the engine 2 to stop when the load shifts to the warming function or the power saving mode, and the control circuit 11 causes the storage battery 14 to supply the power to the load. In this manner, the consumption of the fuel is saved and operation sounds of the engine 2 is reduced while the load is operating in the warming state or in the power saving mode. The control circuit 11 is configured to control a switch circuit 16 to connect the AC/DC circuit 4 or the storage battery 14 to the inverter circuit 5. The switch circuit 16 may be a relay device or a semiconductor switch device configured to switch over input terminals to be connected to an output terminal according to a control signal outputted from the control circuit 11.

A charging circuit 8 is configured to electrically charge the storage battery 14 with the power generated by the power generator 15. Even after the fuel is run out, the power-supplying device 1 can supply to the load 17 the power stored in the storage battery 14. The power source circuit 3, the control circuit 11, the communication circuit 12, and the display device 13 form a load estimating device 100.

[Control Circuit]

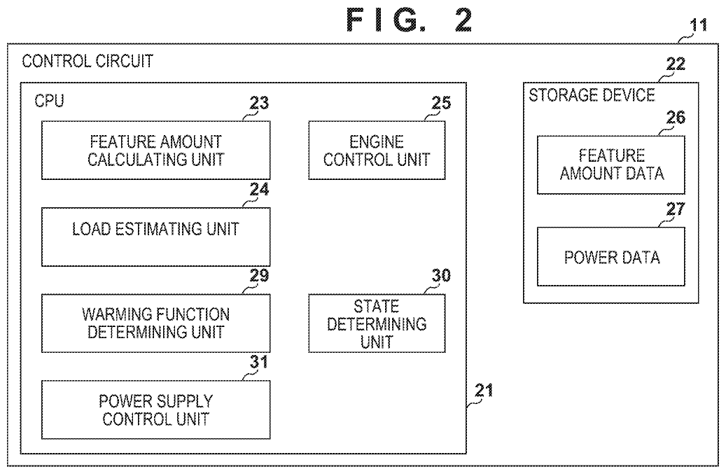

FIG. 2 illustrates the control circuit 11. In FIG. 2, the parts indicated with broken lines are optional. A CPU 21 is a processor circuit (central processing unit) configured to control the power-supplying device 1 according to a control program stored in a storage device 22. Note that the CPU 21 may be a processor circuitry that may have one or more processors, and/or one or more CPU cores, ASIC (application specific integrated circuits) and/or FPGA (field programmable gate array), and/or one or more combinations of them. The storage device 22 is a storage circuit including a non-volatile memory (ROM: Read Only Memory), a volatile memory (RAM: Random Access Memory), or the like.

The CPU 21 has a plurality of functions, which can be realized by the control program. Note that, part or all of the functions may be realized by hardware circuits such as DSP (Digital Signal Processor) or FPGA (Field Programmable Gate Array). A feature amount calculating unit 23 is configured to calculate out the feature amount of the load from the measurement value of the voltage and the measurement value of the current thus measured by the measuring circuit 6. The feature amount may be, for example, an apparent power and a power factor. The power factor may be obtained by diving an effective power with the apparent power or may be calculated out as cos θ of a phase difference between the voltage and the current. In the latter case, the measuring circuit 6 measures the phase difference θ. Further, the feature amount may include a stabilization time, which is a time period necessary from activation of the load to stable operation of the load, or a peak value of an activation current, which flows across the load at the activation of the load. The storage device 22 stores therein feature amount data 26 and power data 27. The feature amount data 26 is data in which types or names (or feature amount identifying information) of loads are associated with feature amounts of the loads. A load estimating unit 24 is configured to estimate what the load connected with the power-supplying device 1 is, the estimating unit 24 performing the estimation on the basis of the feature amount calculated by the feature amount calculating unit 23 and known feature amounts stored in the storage device 22. The power data 27 may include rated power consumptions of the loads and load information indicating, for each of the loads, whether or not the loads have a warming function (or a power saving mode).

A warming function determining unit 29 is configured to determine whether or not the load estimated by the load estimating unit 24 has a warming function. The information indicating, for each of the loads, whether or not the loads have a warming function (or a power saving mode) may be included in the power data 27. Note that, the warming function determining unit 29 may be configured to determine whether or not the load estimated by the load estimating unit 24 has a power saving mode. Whether or not the loads have a power saving mode may be included in the power data 27. A state determining unit 30 is configured to determine, based on the measurement results of the measuring circuit 6, whether or not the load with the warming function has shifted from a heating state to warming state. A power consumption of the heating state may be several times or about ten times greater than that of the warming state. Similarly, the state determining unit 30 is configured to determine, based on the measurement results of the measuring circuit 6, whether or not the load with the power saving mode has shifted from a normal mode to the power saving mode. A power consumption of the normal mode is comparatively higher than that of the power saving mode. A power-supply control unit 31 is configured to control the switch circuit 16 thereby to switch between supplying the power from the power generator 15 to the load or supplying the power from the storage battery 14 to the load. For example, if the load shifts to the warming state or the power saving mode, the power supply control unit 31 stops the engine 2 and switches the switch circuit 16 to supplying the power from the storage battery 14 to the load. The power supply control 31 stops the engine 2 by stopping a fuel supplying device configured to supply the fuel to the engine 2, or stopping an ignition device. An engine control unit 25 is configured to control the fuel supplying device, the ignition device, a starter, and the like, so as to activate or stop the engine 2. The starter may be a recoil starter.

[Feature Amount Map]

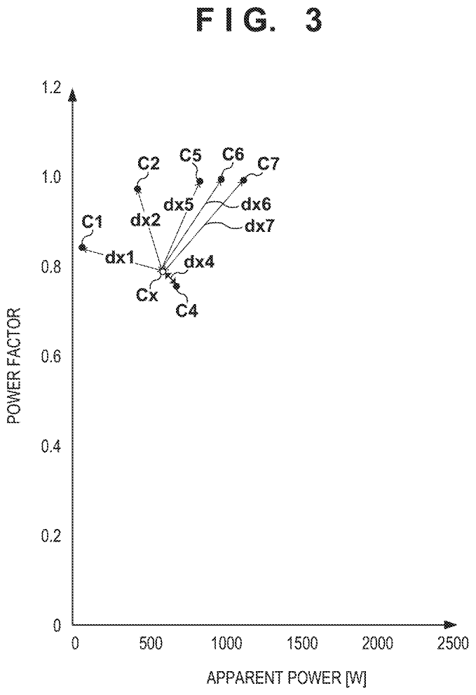

FIG. 3 illustrates a feature amount map constituting part of the feature amount data 26. Here, the apparent power and the power factor are exemplified as the feature amounts. FIG. 3 illustrates coordinates of feature amounts Ci of the load by dots. Here, i is an integer for distinguishing the feature amounts.

A feature amount C1 indicates a feature amount solely of a lighting device.

A feature amount C2 indicates a feature amount solely of a rice cooker.

A feature amount C4 indicates a feature amount solely of a compressor.

A feature amount C5 indicates a feature amount solely of an electric kettle.

A feature amount C6 indicates a feature amount solely of a heater.

A feature amount C7 indicates a feature amount solely of a dryer.

A feature amount Cx indicates a feature amount solely of a load x to be estimated.

The load estimating unit 24 is configured to calculate out a distance dxi between coordinates of the feature amount Cx calculated out by the feature amount calculating unit 23 and coordinates of the feature amounts Ci stored in the storage device 22, and to determine the coordinates of that one of the feature amount Ci stored in the storage device 22 with which a minimum distance dmin can be obtained. The load estimating unit 24 is configured to obtain the type or name (distinguishing information) of the load associated with the feature amount thus determined. In this example, the minimum distance dmin is a distance d×4. That is, the load estimating unit 24 estimates that the load Cx is a compressor because the feature C4 is the most approximate to the feature amount Cx.

[Power Data]

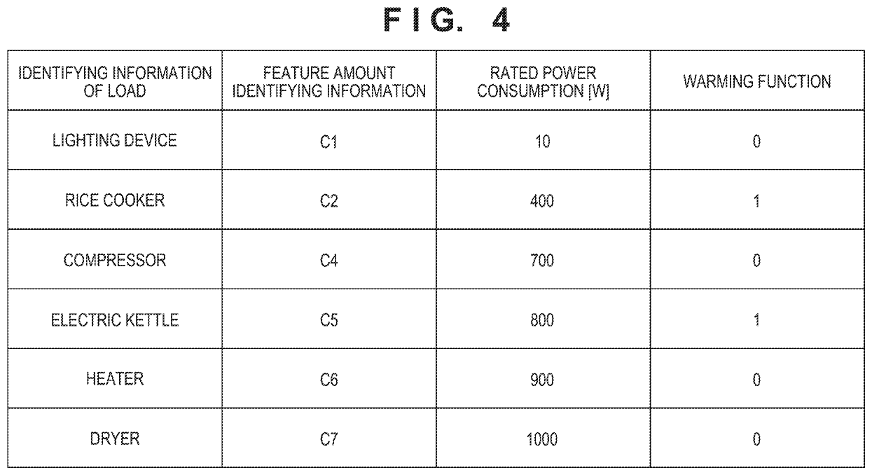

FIG. 4 illustrates one example of the power data 27. The power data 27 includes the rated power consumptions of the loads and the load information indicating, for each of the loads, whether or not the loads have a warming function. One record includes the identifying information, the feature amount identifying information, the rated power consumption, and the load information of a load. The identifying information and the feature amount identifying information of the load may be integrated together. In FIG. 4, the load information is 1-bit information, where “1” indicates that the load has the warming function and “0” indicates that the load does not have the warming function. For example, if the load estimating unit 24 estimates that the load connected with the power-supplying device 1 is an electric kettle, the warming function determining unit 29 obtains the load information corresponding to the electric kettle from the power data 27. Because the load information is “1,” the warming function determining unit 29 determines that the electric kettle has the warming function. If the load estimating unit 24 estimates that the load connected with the power-supplying device 1 is a lighting device, the warming function determining unit 29 obtains the load information corresponding to the lighting device from the power data 27. Because the load information is “0,” the warming function determining unit 29 determines that the lighting device has no warming function.

[Flowchart of Load Estimating Method]

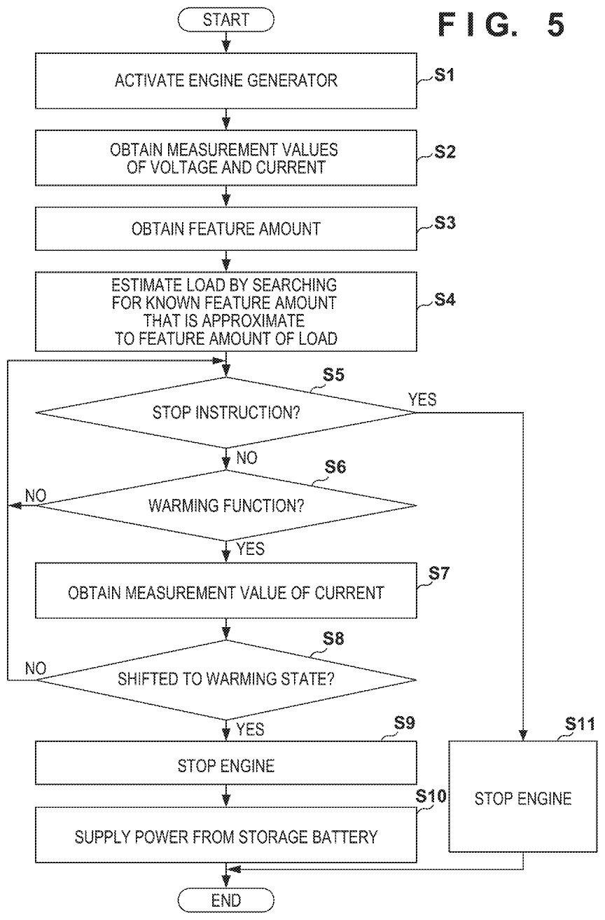

FIG. 5 illustrates a load estimating method executed by the CPU 21 according to the control program. The load estimating method includes a determining process of the warming function and a calming process. The term “calming” means reducing a sound noise or realizing a more silent or quiet environment.

At Step S1, the CPU 21 (engine control unit 25) activates the engine 2. For example, the engine control unit 25 activates the engine 2 by driving the starter for the engine 2, starting the supply of the fuel from the fuel supplying device for the engine 2, and further starting supply of power to the ignition device for the engine 2. At this point, the switch circuit 16 cuts the storage battery 14 off from the inverter circuit 5, and connects the AC/DC circuit 4 with the inverter circuit 5. Note that, the switch circuit 16 may be configured to connect both of the storage battery 14 and the AC/DC circuit 4 with the inverter circuit 5.

At Step S2, the CPU 21 (feature amount calculating unit 23) obtains, by using the measuring circuit 6, the measurement values of the voltage and the current to be supplied to the load 17.

At Step S3, the CPU 21 (feature amount calculating unit 23) obtains the feature amount (for example, the power factor or the apparent power) of the load 17 by using the measurement values of the voltage and current.

At Step S4, the CPU 21 (load estimating unit 24) estimates the load 17 by searching for a known feature amount that is approximate to the feature amount of the load 17. As described above, the storage device 22 stores therein the feature amount data 26 including known feature amounts. Therefore, the load estimating unit 24 determines the feature amount approximate to the feature amount of the load 17 from among the feature amount data 26, and obtains the identifying information of the load associated with the known feature amount thus determined. The identifying information of the load may be the name or type of the load, for example.

At Step S5, the CPU 21 (engine control unit 25) determines whether or not stopping of the engine 2 is instructed via the touch screen of the display device 13 or a stop switch. If a user has instructed the stopping, the CPU 21 goes to Step S11. At Step S11, the CPU 21 (engine control unit 25) stops the engine 2. If the user has not instructed the stopping, the CPU 21 goes to Step S6.

At Step S6, the CPU 21 (warming function determining unit 29) determines whether or not the load 17 estimated by the load estimating unit 24 has a warming function. For example, the warming function determining unit 29 refers to the power data 27, obtains the load information from the record corresponding to the load 17, and determines, based on the load information, whether or not the load 17 has a warming function. The warming function determining unit 29 obtains the identifying information and the feature amount identifying information of the load 17 from the load estimating unit 24, searches for the record associated with the identifying information and the feature amount identifying information, and obtains the load information from the record thus searched out. If the load 17 does not have a warming function, the CPU 21 returns to Step S5. On the other hand, if the load 17 has a warming function, the CPU 21 goes to Step S7.

At Step S7, the CPU 21 (state determining unit 30) obtains, from the measuring circuit 6, the measurement value of the current flowing across the load 17.

At Step S8, the CPU 21 (state determining unit 30) determines, based on the measurement value of the current, whether or not the load 17 has shifted from the heating state to the warming state. For example, if the measurement value of the current drops to a value equal to or less than a threshold, the state determining unit 30 determines that the load 17 has shifted to the warming state. Note that, the threshold is set between a current value in the heating state and a current value in the warming state. These current values or the threshold may be included in the power data 27, and used for the determination. If the load 17 has shifted to the warming sate, the CPU 21 goes to Step S9. If the load 17 has not shifted to the warming sate, the CPU 21 returns to Step S5.

At Step S9, the CPU 21 (the power supply control unit 31 and the engine control unit 25) stops the engine 2. This realizes calming. The power supply control unit 31 instructs the engine control unit 25 to stop the engine 2. The engine control unit 25 stops the fuel supply device and the ignition device, thereby stopping the engine 2.

At Step S10, the CPU 21 (power supply control unit 31) supplies the power from the storage battery 14 to the load 17. For example, the power supply control unit 31 switches over the switch circuit 16, thereby connecting the storage battery 14 and the inverter circuit 5 and cutting the AC/DC circuit 4 off from the inverter circuit 5. The inverter circuit 5 converts the direct current supplied from the storage battery 14 into an alternating current, and supplies the alternating current to the load 17.

[Other Configurations]

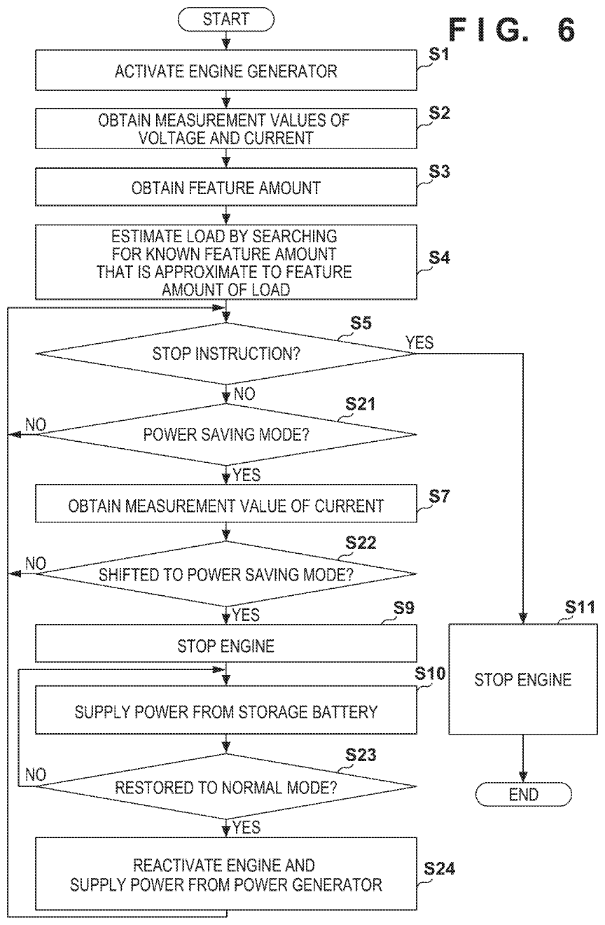

FIG. 6 illustrates a load estimating method performed by the CPU 21 according to a control program. The load estimating method includes a determining process for determining the power saving mode and a calming process. In FIG. 6, like processes common to these in FIG. 5 are labelled with like reference numerals, and the explanations made for FIG. 5 are not repeated here. In FIG. 6, if the stopping instruction is not detected at Step S5, the CPU 21 goes to S21. Note that, the warming function determining unit 29 functions as a power saving mode determining unit herein. The state determining unit 30 determines whether or not the normal mode has shifted to the power saving mode, or whether or not the power saving mode has shifted to the normal mode. Moreover, the power data 27 includes load information indicating whether or not the load 17 has a power saving mode, instead of the load information indicating whether or not the load 17 has a warming function.

At Step S21, the CPU 21 (the warming function determining unit 29) determines whether or not the load 17 estimated by the load estimating unit 24 has a power saving mode. For example, the warming function determining unit 29 refers to the power data 27, obtains the load information from a record associated with the load 17, and determines, based on the load information, whether or not the load 17 has a power saving mode. The warming function determining unit 29 obtains the identifying information and the feature amount identifying information of the load 17 from the load estimating unit 24, searches for the record associated with the identifying information and the feature amount identifying information, and obtains the load information from the record thus searched out. If the load 17 does not have a power saving mode, the CPU 21 returns to Step S5. On the other hand, if the load 17 has a power saving mode, the CPU 21 goes to Step S7. After performing Step S7, the CPU 21 goes to Step S22.

At Step S22, the CPU 21 (the state determining unit 30) determines, based on the measurement value of the current, whether or not the load 17 has shifted from the normal mode (non-power saving mode) to the power saving mode. For example, if the measurement value of the current drops to a value equal to or less than a threshold, the state determining unit 30 determines that the load 17 has shifted to the power saving mode. Note that, the threshold is set between a current value in the non-power saving mode and a current value in the power saving mode. These current values or the threshold may be included in the power data 27 and used in the determination. If the load 17 has not shifted to the power saving mode, the CPU 21 returns to Step S5. If the load 17 has shifted to the power saving mode, the CPU 21 goes to Step S9. After performing Steps S9 and S10, the CPU 21 goes to Step S23. The power saving mode may be referred to as a standby mode or a sleep mode.

At Step S23, the CPU 21 (the state determining unit 30) determines, based on the measurement value of the current, whether or not the load 17 has shifted back from the power saving mode to the normal mode. For example, if the measurement value of the current exceeds the threshold, the state determining unit 30 determines that the load 17 has shifted back to the normal mode. If the load 17 has not shifted back to the normal mode, the CPU 21 returns to Step S10. On the other hand, if the load 17 has shifted back to the normal mode, the CPU 21 goes to Step S24.

At Step S24, the CPU 21 (the power supply control unit 31 and the engine control unit 25) reactivates the engine 2, and supplies the power outputted to the power generator 15 to the load 17. For example, based on a control signal from the power supply control unit 31, the switch circuit 16 cuts the storage battery 14 off from the inverter circuit 5, and connects the AC/DC circuit 4 with the invert circuit 5. As an alternative, the switch circuit 16 may be configured to connect both of the storage battery 14 and the AC/DC circuit 4 with the inverter circuit 5.

[Summary]

A first aspect provides a portable power-supplying device 1, including a power generator 15 that generates power by being driven by an engine 2 and a storage battery 14 being chargeable with the power generated by the power generator 15. The measuring circuit 6 is one example of a measuring unit configured to measure a voltage and a current supplied to a load 17. The CPU 21 or the feature amount calculating unit 23 is one example of a calculating unit configured to calculate out a feature amount of the load 17 from a measurement value of the voltage and a measurement value of the current thus measured by the measuring unit. The storage device 22 is one example of a storage unit configured to store therein feature amounts of loads in advance. The CPU 21 or the load estimating unit 24 is one example of a load estimating unit configured to estimate what a load connected with the power-supplying device 1 is, on the basis of the feature amount thus calculated out by the calculating unit and the feature amounts stored in the storage unit. The CPU 21 or the state determining unit 30 is one example of a state determining unit configured to determine, if the load estimated by the load estimating unit has a warming function for keeping warm, whether or not the load has shifted from a heating state to a warming state, on the basis of the current measured by the measuring unit. The CPU 21, the power supply control unit 31, or the like is one example of a control unit configured to activate the engine 2 and supply the power generated by the power generator 15 to the load 17 if an operation state of the load 17 is the heating state, and stop the engine 2 and supply the power stored in the storage battery 14 to the load if the operation state of the load 17 has shifted from the heating state to the warming state. With this configuration, it becomes possible to attain such power supply that, if the load 17 connected with the portable power-supply device 1 has shifted from the heating state to the warming state, the engine 2 is stopped and the power is supplied from the storage battery 14. This results in that no operation sounds of the engine 2 are generated and no consumption of the fuel occurs during a period in which the load 17 is in the warming state. It may be so configured that, if the charge remained in the storage battery 14 becomes little, the CPU 21 reactivates the engine 2 in order to cause the power generator 15 to supply the power to the load 17 and to recharge the storage battery 14.

According to a second aspect, the storage unit may store load information indicating, for each of the loads, whether or not the loads have a warming function, and the portable power-supplying device 1 may further comprise a warming determining unit configured to determine, based on the load information, whether or not the load estimated by the load estimating unit has a warming function. The warming function determining unit 29 is one example of the warming determining unit.

A third aspect provides a portable power-supplying device 1 including a power generator 15 that generates power by being driven by an engine 2 and a storage battery 14 being chargeable with the power generated by the power generator 15. The measuring circuit 6 is one example of a measuring unit configured to measure a voltage and a current supplied to a load. The CPU 21 or the feature amount calculating unit 23 is one example of a calculating unit configured to calculate out a feature amount of the load from a measurement value of the voltage and a measurement value of the current measured by the measuring unit. The storage device 22 is one example of a storage unit configured to store feature amounts of loads in advance. The CPU 21 or the load estimating unit 24 is one example of a load estimating unit configured to estimate what a load connected with the power-supplying device is, on the basis of the feature amount calculated out by the calculating unit and the feature amounts stored in the storage unit. The CPU 21 or the state determining unit 30 is one example of a determining unit configured to determine, if the load estimated by the load estimating unit has a high power consumption state and a low power consumption state, whether or not the load has shifted from the high power consumption state to the low power consumption state, on the basis of the current measured by the measuring unit. The normal mode or the non-power saving mode is one example of the high power consumption state. The power saving mode is one example of the low power consumption state. The CPU 21, the power supply control unit 31, or the like is one example of a control unit configured to activate the engine 2 and supply the power generated by the power generator 15 to the load 17 if an operation state of the load 17 is the high power consumption state, and stop the engine 2 and supply the power stored in the storage battery 14 to the load 17 if the operation state of the load 17 has shifted from the high power consumption state to the low power consumption state. This results in that no operation sounds of the engine 2 are generated and no consumption of the fuel occurs in a period in which the load 17 is in the power saving mode. It may be so configured that, if the charge remained in the storage battery 14 becomes little, the CPU 21 reactivates the engine 2 in order to cause the power generator 15 to supply the power to the load 17 and to recharge the storage battery 14.

According to a fourth aspect, the load 17 may be a rice cooker, an electric kettle, or a cooking device, which have a warming function.

According to fifth aspect, the load 17 may be a refrigerator having a cooling function for keeping cool. It is expected that the use of portable refrigerators will become more popular for camping in summer times. Refrigerators consume a large amount of power until a temperature inside thereof reaches a predetermined temperature, and consume a small amount of power after the temperature inside thereof reaches the predetermined temperature. Therefore, the explanation in the embodiment of the present invention can be read, replacing the term “warming function” with the term “cooling function.”

According to a sixth aspect, the load 17 may be an electric device having a normal mode (non-power saving mode) corresponding to the high power consumption state and a power saving mode corresponding to the low power consumption state.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A portable power-supplying device, comprising:
a power generator that generates power by being driven by an engine;
a storage battery being chargeable with power generated by the power generator;
a measuring unit configured to measure a voltage and a current supplied to a load;
a calculating unit configured to calculate out a feature amount of the load from a measurement value of the voltage and a measurement value of the current measured by the measuring unit;
a storage unit configured to store feature amounts of loads in advance;
a load estimating unit configured to estimate what a load connected with the power-supplying device is, on the basis of the feature amount calculated out by the calculating unit and the feature amounts stored in the storage unit;
a state determining unit configured to determine, if a load estimated by the load estimating unit has a warming function for keeping warm, whether or not the load has shifted from a heating state to a warming state, on the basis of the current measured by the measuring unit; and
a control unit configured to activate the engine and supply the power generated by the power generator to the load in a case where an operation state of the load is the heating state, and stop the engine and supply the power stored in the storage battery to the load in a case where the operation state of the load has shifted from the heating state to the warming state.

2. The portable power-supplying device according to claim 1, wherein
the storage unit stores load information indicating, for each of the loads, whether or not the loads have a warming function, and
the portable power-supplying device further comprises:
a warming determining unit configured to determine, based on the load information, whether or not a load estimated by the load estimating unit has a warming function.

3. The portable power-supplying device according to claim 1, wherein
the load is a rice cooker, an electric kettle, or a cooking device, which have a warming function.

4. The portable power-supplying device according to claim 1, wherein
the load is a refrigerator having a cooling function for keeping cool.

5. A portable power-supplying device, comprising:
a power generator that generates power by being driven by an engine;
a storage battery being chargeable with power generated by the power generator;
a measuring unit configured to measure a voltage and a current supplied to a load;
a calculating unit configured to calculate out a feature amount of the load from a measurement value of the voltage and a measurement value of the current measured by the measuring unit;
a storage unit configured to store feature amounts of loads in advance;
a load estimating unit configured to estimate what a load connected with the power-supplying device is, on the basis of the feature amount calculated out by the calculating unit and the feature amounts stored in the storage unit;
a determining unit configured to determine, if a load estimated by the load estimating unit has a high power consumption state and a low power consumption state, whether or not the load has shifted from the high power consumption state to the low power consumption state on the basis of the current measured by the measuring unit; and
a control unit configured to activate the engine and supply the power generated by the power generator to the load in a case where an operation state of the load is the high power consumption state, and stop the engine and supply the power stored in the storage battery to the load in a case where the operation state of the load has shifted from the high power consumption state to the low power consumption state.

6. The portable power-supplying device according to claim 5, wherein
the load is a rice cooker, an electric kettle, or a cooking device, which have a warming function.

7. The portable power-supplying device according to claim 5, wherein
the load is a refrigerator having a cooling function for keeping cool.

8. The portable power-supplying device according to claim 5, wherein
the load is an electric device having a normal mode corresponding to the high power consumption state and a power saving mode corresponding to the low power consumption state.

9. A portable power-supplying device, comprising:
a power generator that generates power by being driven by an engine;
a storage battery being chargeable with power generated by the power generator;
a measuring circuitry configured to measure a voltage and a current supplied to a load;
one or more processors configured to calculate out a feature amount of the load from a measurement value of the voltage and a measurement value of the current measured by the measuring circuitry,
a storage device configured to store feature amounts of loads in advance,
wherein the one or more processors are further configured to:
estimate what a load connected with the power-supplying device is, on the basis of the feature amount calculated out and the feature amounts stored in the storage device;
determine, if a load estimated has a warming function for keeping warm, whether or not the load has shifted from a heating state to a warming state, on the basis of the current measured by the measuring circuitry; and
activate the engine and supply the power generated by the power generator to the load in a case where an operation state of the load is the heating state, and stop the engine and supply the power stored in the storage battery to the load in a case where the operation state of the load has shifted from the heating state to the warming state.
